(19) United States
(12) Patent Application Publication
(10) Pub. No.: US 2026/0142138 A1
(43) Pub. Date: May 21, 2026

(54) ION SOURCE, MASS SPECTROMETER AND METHOD FOR GENERATING IONS

(71) Applicant: SHIMADZU CORPORATION, Kyoto-shi (JP)

(72) Inventors: Zhi GENG, Shanghai (CN); Xiaoqiang ZHANG, Shanghai (CN); Wenjian SUN, Shanghai (CN)

(21) Appl. No.: 19/389,745

(22) Filed: Nov. 14, 2025

(30) Foreign Application Priority Data
Nov. 19, 2024 (CN) 202411657795.3

(51) Int. Cl. H01J 49/16

(52) U.S. Cl. CPC H01J 49/164

(57) ABSTRACT

This application relates to the field of ion analysis, in particular to an ion source, a mass spectrometer and a method for generating ions. The ion source includes a substrate, a first laser generator, a second laser generator, a detector, and an actuating device. The substrate carries a sample. The first laser generator projects a first laser beam to the substrate, thereby desorbing and ionizing the sample to obtain a particle plume. The second laser generator ionizes the particle plume to obtain signal ions, focus of the second laser generator being located on a side of the sample away from the substrate and disposed a predetermined distance away from the substrate. The detector detects a signal intensity of the signal ions. The actuating device moves the focus of the second laser generator. A destination where the focus is moved to is determined by comparison between different signal intensities detected by the detector during a movement of the focus. The ion source can accurately focus a post-ionization laser beam to keep the ion source working in a better state.

### BACKGROUND

This application relates to the technical field of ion analysis, and in particular to an ion source, a mass spectrometer and a method for generating ions.

MALDI-2 is a laser-induced MALDI (Matrix-assisted laser desorption/ionization) post-ionization method, which can improve the sensitivity of various analytes (such as phospholipids and glycolipids, steroids, glycans and drugs) by 1 to 3 orders of magnitude (Science, 2015, 10, 348(6231), 211-5). However, commercially available MALDI- 2 ion sources are all operated under vacuum conditions, which makes sample loading difficult and is not suitable for analyzing volatile samples.

Niehaus et al. have reported a homemade MALDI-2 ion source operating at atmospheric pressure (J. Am. Soc. Mass Spectrom. 2020, 31, 11, 2287-2295) and demonstrated the possibility of operating MALDI-2 at atmospheric pressure. However, operating MALDI-2 at atmospheric pressure remains challenging, particularly with the alignment of a post-ionization laser beam.

### SUMMARY

Theoretically, the post-ionization laser beam should overlap with a particle plume ablated by an ablation laser. However, in the process of creating this application, the inventors have found that at atmospheric pressure, the size of the particle plume may be very small, and thus a focus of the post-ionization laser beam has to be aligned with micron-level precision. In the reported MALDI-2 ion sources, whether in a vacuum environment or an atmospheric environment, the alignment of the post-ionization laser beam is achieved by precise mechanical calibration prior to testing, and the post-ionization laser beam is also mechanically fixed during the operation of the ion sources. For this reason, the user cannot determine whether the MALDI-2 ion source is working in an optimal state to achieve maximum sensitivity. In addition, many factors may cause mechanical errors in the alignment of the laser with the particle plume, such as substrate unevenness, electric field or airflow interference, which may cause MALDI-2 to fail to work in the optimal state.

Therefore, how to more accurately focus the post-ionization laser beam to keep the ion source working in the optimal or better state is a technical problem to be solved urgently.

A first aspect of this application provides an ion source including a substrate, a first laser generator, a second laser generator, a detector and an actuating device. The substrate carries a sample. The first laser generator projects a first laser beam to the substrate, thereby desorbing and ionizing the sample to obtain a particle plume. The second laser generator ionizes the particle plume to obtain signal ions, focus of the second laser generator being located on a side of the sample away from the substrate and disposed a predetermined distance away from the substrate. The detector detects a signal intensity of the signal ions. The actuating device is configured to move the focus of the second laser generator, the destination where the focus is moved to being determined by comparison between different signal intensities detected by the detector during a movement of the focus.

Optionally, the second laser generator includes a laser emitter and an optical lens assembly, the optical lens assembly is arranged in a laser path of the laser emitter, the actuating device is connected to the optical lens assembly, and the actuating device alters the laser path of the laser emitter by moving or rotating the optical lens assembly.

Optionally, the ion source further includes a sensor that receives a second laser beam from the second laser generator, and the destination of the focus is also determined based on a detection result of the sensor.

Optionally, the detection result of the sensor includes light spot's shape, light spot's relative position and/or laser energy.

Optionally, the second laser generator includes a reflecting mirror that refocuses a second laser beam, and the second laser beam has been focused on a first position of the particle plume, and is refocused on a second position of the particle plume by the reflecting mirror.

Optionally, the reflecting mirror is a concave mirror.

Optionally, the position or angle of the reflecting mirror is determined by comparison between different signal intensities detected by the detector during a movement or rotation of the reflecting mirror.

3 Optionally, working air pressure of the ion source is 1 Pa-1 atm.

Optionally, the ion source is an atmospheric pressure ion source.

Optionally, the substrate includes a standard sample area and a test sample area, and the ion source is configured to move the substrate to detect the sample in the test sample area, after determining the destination where the focus of the second laser generator is moved to according to the standard sample area.

Optionally, the movement of the focus which the actuating device operates has a component in a direction parallel to a surface of the substrate.

Optionally, the movement of the focus which the actuating device operates further has a component in a direction perpendicular to the surface of the substrate.

Optionally, the predetermined distance is 0.01-5 mm.

Optionally, in a region adjacent to the substrate, a laser path of the first laser generator is in a direction inclined to a surface of the substrate, and a laser path of the second laser generator is in a direction parallel to the surface of the substrate.

Optionally, the ion source further includes a controller in communication with the detector and the actuating device, and the destination of the focus is determined by the controller.

A second aspect of this application further provides a mass spectrometer including the ion source provided in the first aspect of this application.

A third aspect of this application further provides a method for generating ions, the method including the following steps:
desorbing and ionizing a sample by a first laser beam to obtain a particle plume;
ionizing the particle plume by a second laser beam to obtain signal ions;
moving a focus of the second laser beam, meanwhile, detecting a signal intensity of the signal ions;
determining the destination of the focus of the second laser beam based on comparison between different signal intensities corresponding to different focuses of the second laser beam;
immobilizing the focus of the second laser beam at the destination.

### BRIEF DESCRIPTION OF THE SEVERAL VIEWS OF THE DRAWINGS

FIG. 1 is a schematic structural diagram of an ion source according to one or more embodiments of this application.

FIG. 2 is a schematic structural diagram of a preferred ion source according to another embodiment of this application.

FIG. 3 is a schematic structural diagram of a configuration of an optical lens assembly in some embodiments of FIG. 2.

FIG. 4 is a schematic structural diagram of a system of a mass spectrometer according to some embodiments of this application.

FIG. 5 is a flowchart of a method for generating ions according to some embodiments of this application.

Reference numerals: ion source 100, substrate 1, standard sample area 1a, test sample area 1b, first laser generator 2, first laser beam 2a, second laser generator 3, second laser beam 3a, laser emitter 3b, optical lens assembly 3c, first reflecting mirror 31c, first convex lens 32c, second reflecting mirror 33c, detector 4, actuating device 5, controller 6, vacuum port 200, ion guiding device 300, mass detector 400, particle plume PP, and focus FP.

### DETAILED DESCRIPTION OF THE DISCLOSURE

Some embodiments of this application are described below with reference to the accompanying drawings. Those skilled in the art should understand that these embodiments are merely used to explain the technical principles of this application, and are not intended to limit the protection scope of this application.

The term “desorption and ionization” refers to the process of desorbing a sample from a surface of a substrate 1 and ionizing the sample, and the desorption and ionization can be completed simultaneously or in different time periods, which is not limited in this application.

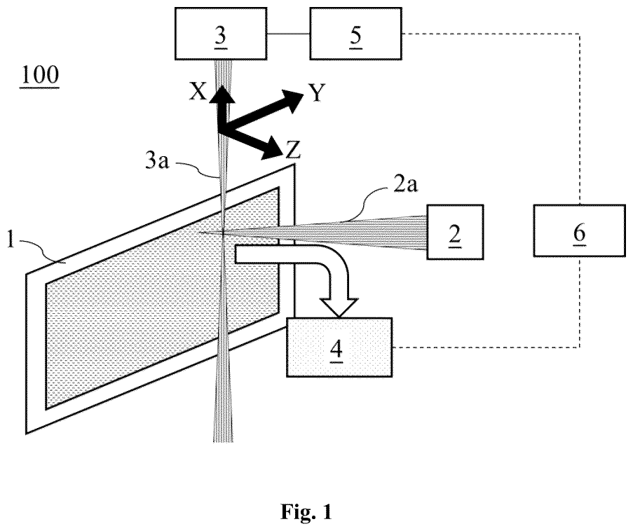

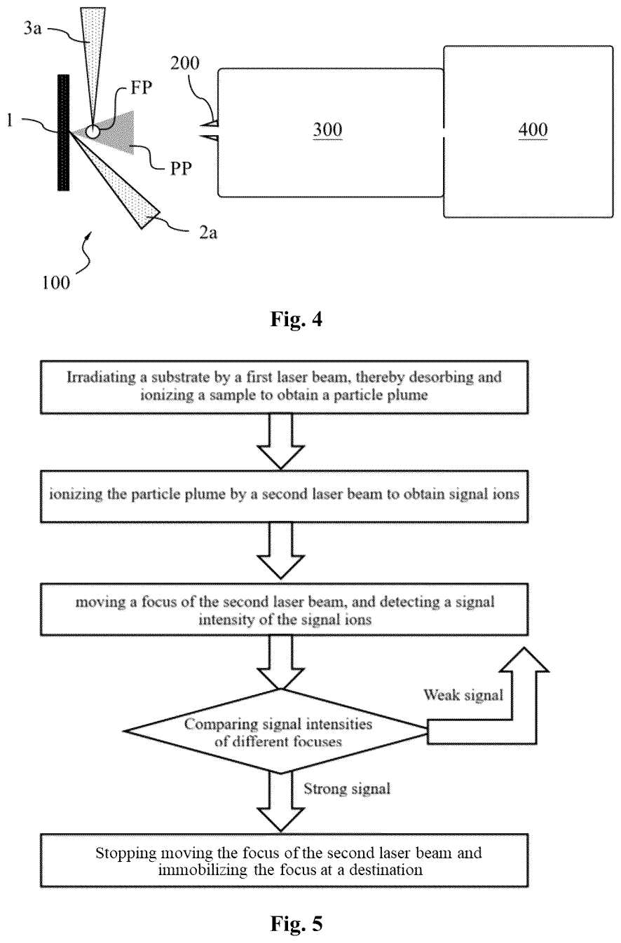

FIG. 1 is a schematic structural diagram of an ion source 100 according to one or more embodiments of this application. As shown in FIG. 1, the ion source 100 is a MALDI-2 ion source 100. “2” in “MALDI-2” indicates that a second laser beam 3a is used, that is, a second laser generator 3 is used to perform secondary ionization (or post-ionization) on particles/ions formed by primary desorption/ionization. The MALDI-2 ion source 100 according to this embodiment may be applied to an atmospheric pressure or low pressure environment. Due to the high ambient air pressure, the air pressure environment will generate a compression effect on a particle plume PP (referring to FIG. 4), making it difficult to fully expand the particle plume PP, thereby imposing more stringent requirements on the focusing accuracy of the second laser beam 3a.

The ion source 100 according to this embodiment includes the substrate 1, a first laser generator 2, the second laser generator 3, a detector 4, an actuating device 5, and a controller 6.

The substrate 1 is used to carry a sample, and the specific material thereof is not limited. In some preferred embodiments, the substrate 1 may be a metal plate or a plate having a conductive layer, so that a certain electric field may be applied to the substrate 1. Alternatively, in other preferred embodiments, the substrate 1 may also be a transparent plate, such as a glass plate, so that a laser generator (first laser generator 2 and/or second laser generator 3) may be arranged on a side of the substrate 1 away from the sample, and a light beam emitted by the laser generator may irradiate the sample through the substrate 1.

A first laser beam 2a emitted by the first laser generator 2 and the second laser beam 3a emitted by the second laser generator 3 contain high-energy photons capable of desorbing and ionizing sample particles. The first laser generator 2 may be arranged on the same side of the substrate 1 as the sample, or may be arranged on the side of the transparent substrate 1 away from the sample, as long as an emission surface of the first laser generator 2 faces the substrate 1 or the emitted laser beam is directed to the substrate 1. The first laser generator 2 can project the first laser beam 2a to the sample on the substrate 1, thereby desorbing and ionizing the sample. The sample is preliminarily dissociated by the first laser beam 2a to form ions, and the sample ions diffuse to a side away from the substrate 1 to form a particle plume PP.

A focus FP (referring to FIG. 4) of the second laser generator 3 is located on a side of the sample away from the substrate 1 and is spaced apart from the substrate 1 by a predetermined distance, that is, the focus is preset to align with a region where the particle plume PP is located. The “predetermined distance” may be freely selected according to specific conditions. Generally, the predetermined distance is preferably 0.01-5 mm, and an ion concentration in the particle plume PP in this region is relatively high. The second laser beam 3a emitted by the second laser generator 3 may perform secondary ionization on the particle plume PP at the focus FP to obtain signal ions. The first laser generator 2 first desorbs and ionizes the sample to obtain the particle plume PP, and then performs post-ionization on the particle plume PP, which may improve the ionization effect of various analytes and improve the detection sensitivity of the detector 4.

In a region adjacent to the substrate 1, within a range corresponding to the surface of the substrate 1, a laser path of the second laser beam 3a is preferably in a direction parallel to the surface of the substrate 1 and focused on the particle plume PP at a predetermined distance from the sample. A laser path of the first laser beam 2a emitted by the first laser generator 2 may be incident in a direction perpendicular to the surface of the substrate 1, that is, the laser path of the first laser beam 2a may be perpendicular to the laser path of the second laser beam 3a. Preferably, the laser path of the first laser beam 2a is incident in a direction inclined to the surface of the substrate 1 and focused on the sample on the surface of the substrate 1.

The signal ions obtained by irradiating the particle plume PP by the second laser generator 3 enter the detector 4, the detector 4 calculates a signal intensity of the signal ions based on the detected amount of signal ions, and the detector 4 may be a mass detector or any other suitable type of sensor that can detect the amount of ions. In some embodiments, the ion source 100 according to this embodiment may be used as the ion source 100 of a mass spectrometer, and the signal intensity is detected by a mass detector of the mass spectrometer, such as a quadrupole mass analysis device or a detector of a time-of-flight mass spectrometer.

The ion source 100 may cause the second laser beam 3a to fail to accurately focus on the particle plume PP due to reasons such as sample loading batches, equipment handling, and system errors/tolerances, and thus the focus of the second laser beam 3a needs to be calibrated. To achieve a more accurate calibration process, the ion source 100 according to this embodiment further includes the actuating device 5 and the controller 6.

The actuating device 5 is configured to move the focus FP of the second laser generator 3, and a specific moving structure of the actuating device 5 is not limited herein, and may be in the form of a rotating shaft structure or a moving track. For example, in some preferred embodiments, the second laser generator 3 may be integrally fixed on the moving track, or a part of the second laser generator 3, such as an optical lens assembly, may be fixed on the moving track. The focus FP of the laser beam emitted by the second laser generator 3 may be adjusted by controlling the movement of the entire or part of the second laser generator 3. Alternatively, in some other preferred embodiments, one or more lenses or mirrors in the optical lens assembly of the second laser generator 3 may be mounted on the rotating shaft structure, so that the focus FP of the second laser beam 3a emitted by the second laser generator 3 is adjusted by rotating the rotating shaft structure, which all fall within the protection scope of this application.

By flexibly moving the second laser generator 3, the focus FP of the second laser generator 3 can be adjusted according to a diffusion direction of the particle plume PP. Generally, the second laser generator 3 may be moved in X-axis and Y-axis directions horizontal to the substrate 1 and a Z-axis direction perpendicular to the substrate 1. By the movement in the above directions, the second laser generator 3 can be adjusted to focus at any position in the particle plume PP region.

In some embodiments, the controller 6 is in communication with the detector 4 and is also in communication with the actuating device 5, and the controller 6 determines a destination of the focus FP of the second laser generator 3 based on comparison between different signal intensities detected by the detector 4 during a movement of the focus FP. Specifically, before initiating the calibration process of the second laser generator 3, the position and orientation of the first laser generator 2 are fixed first, so that the first laser beam 2a emitted by the first laser generator 2 is focused on the sample on the surface of the substrate 1. Next, the second laser generator 3 is calibrated. When the focus FP of the second laser generator 3 is located at point A₁, the signal intensity detected by the detector 4 is I₁. As the second laser generator 3 moves or rotates, the focus FP moves to point A₂, A₃, A₄, . . . , Aₙ in sequence, and correspondingly, the signal intensity detected by the detector 4 at each point is I₂, I₃, I₄, . . . , Iₙ, respectively. Thereafter, the signal intensities at the points are compared. For example, if the detection result shows that I₄ in I₁˜In is the maximum value, it can be determined that A₄ is a reasonable focus FP, and a movable part of the actuating device 5 of the second laser generator 3 can be fixed to fix the focus FP of the second laser generator 3. In the subsequent test process, the second laser generator 3 is always fixedly focused on point A₄, and the point A₄ is the destination of the focus FP of the second laser generator 3 in this example.

By acquiring different signal intensities detected by the detector 4 during the movement of the focus FP, the most reasonable or more reasonable focus FP can be effectively determined, and a post-ionization effect of the second laser generator 3 can be improved.

Since the second laser beam 3 a is very close to the substrate (0.01-5 mm), the high-energy laser beam is likely to be mistakenly incident on the substrate 1 during movement, causing damage to the sample on the substrate 1. Preferably, the ion source 100 in some embodiments further includes a sensor (not shown), and the second laser beam 3a is received by the sensor after passing through the particle plume PP. The sensor may be a charge-coupled device, and may detect light spot's shape, light spot's relative position and/or laser energy of the received second laser beam 3a. Under the initial conditions, a relative position between the second laser beam 3a and the substrate 1 can be roughly determined according to the light spot's relative position, thereby shortening the debugging time. During the movement of the second laser beam 3a, it is possible to determine whether the second laser beam 3a is mistakenly incident on the substrate 1 according to the light spot's shape, light spot's relative position and/or laser energy, and to make corrections in time.

The ion source 100 in some embodiments can maintain high detection sensitivity at large working air pressure. Specifically, working air pressure of the ion source 100 according to this embodiment is 1 Pa-1 atm. In some embodiments, the ion source 100 may be applied to an atmospheric pressure environment, that is, the ion source 100 provided in this implementation may be an atmospheric pressure ion source.

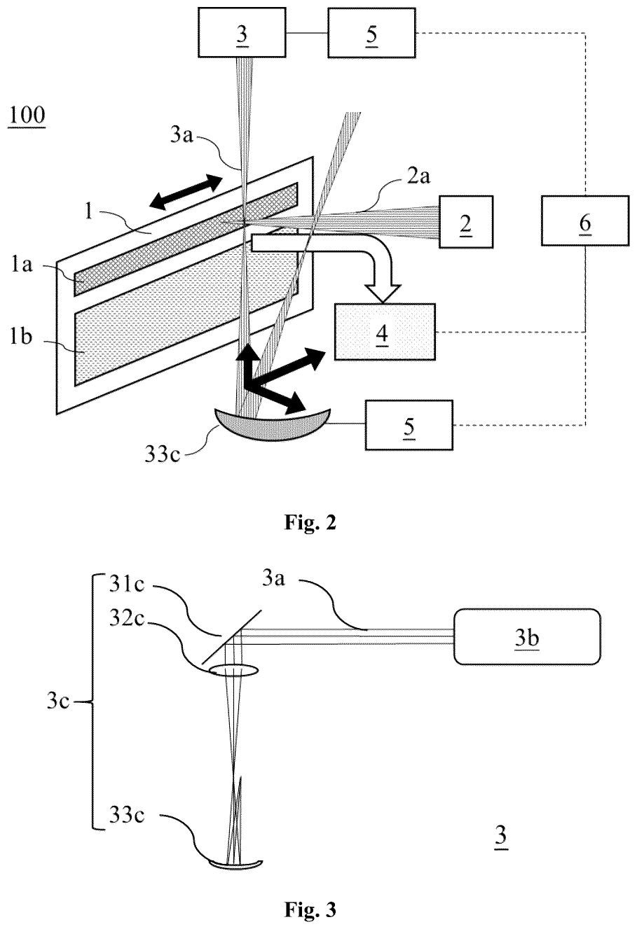

FIG. 2 is a schematic structural diagram of the preferred ion source 100 according to another embodiment of this application. FIG. 3 is a schematic diagram of a configuration of an optical lens assembly in some embodiments of FIG. 2. With reference to FIG. 2 and FIG. 3, the second laser generator 3 includes a laser emitter 3b and an optical lens assembly 3c, and an optical lens assembly 3c is arranged in a laser path of the laser emitter 3b. The laser emitter 3b has a large volume and weight, and in order to facilitate movement and improve the stability of the laser light path during movement, the actuating device 5 may be connected to the optical lens assembly 3c. The actuating device 5 may change the laser path of the laser emitter 3b by moving or rotating the optical lens assembly 3c, so that the focus FP of the laser beam may be changed without moving the laser emitter 3b. The optical lens assembly 3c may include one or more lenses, for example, may be a convex lens, a concave lens, a reflecting mirror, or a combination of any one or more thereof, which is not limited herein.

In some embodiments, as shown in FIG. 3, the optical lens assembly 3 c of the second laser generator 3 may include a first reflecting mirror 31c and a first convex lens 32c, the first reflecting mirror 31c is configured to guide the second laser beam 3a emitted by the second laser generator 3 toward a direction parallel to the substrate 1, and the first convex lens 32c may focus the laser beam. The laser emitter 3b emits a laser beam toward the first reflecting mirror 31c, the first reflecting mirror 31c and the first convex lens 32c are both connected to the actuating device 5, the actuating device 5 can adjust a distance between the emitted laser beam and the substrate 1 by moving the first reflecting mirror 31c in the direction perpendicular to the surface of the substrate 1, and can move the focus FP of the laser beam by moving the first convex lens 32c. In the above manner, the focus FP of the second laser beam 3a may be adjusted in a plurality of directions by moving the first reflecting mirror 31c and the first convex lens 32c in combination. In some embodiments, the first reflecting mirror 31c is represented by a single reflecting mirror, and in other embodiments, a reflecting mirror group may be used instead of a single reflecting mirror to conveniently guide the laser beam emitted by the second laser generator 3 toward the direction parallel to the substrate 1.

Further, the optical lens assembly 3c may further include a second reflecting mirror 33c that refocuses a laser beam, and the laser beam has been focused on a first position of the particle plume PP, and is refocused on a second position of the particle plume PP by the reflecting mirror 33c. Further, FIG. 2 and FIG. 3 illustrate a case where the reflecting mirror is a concave mirror. The first position and the second position may be two independent sub-regions in the region where the particle plume PP is located, or may be two partially intersecting sub-regions, or may be two overlapping sub-regions.

According to the above structure of the optical lens assembly 3 c, preferably, when the actuating device 5 moves the optical lens assembly 3c, the controller 6 further analyzes and determines the position or angle of the second reflecting mirror 33c based on the comparison between different signal intensities detected by the detector 4 during the movement or rotation of the second reflecting mirror 33c. Specifically, the actuating device 5 may first rotate the focus of the second reflecting mirror 33c to a position away from the particle plume PP, move or rotate the first reflecting mirror 31c and the first convex lens 32c, select the first position with a higher signal intensity based on the comparison between different signal intensities detected by the detector 4 during the movement or rotation of the first reflecting mirror 31c and the first convex lens 32c, and then fix the positions and orientations of the first reflecting mirror 31c and the first convex lens 32c. Thereafter, the actuating device 5 only moves or rotates the second reflecting mirror 33c, selects the second position with a higher signal intensity based on the comparison between different signal intensities detected by the detector 4 during the movement or rotation of the second reflecting mirror 33c, and fixes the position and orientation of the second reflecting mirror 33c. In the above manner, not only the accuracy of the focus FP for the primary focusing can be ensured, but the accuracy of the focus for the secondary focusing by the second reflecting mirror 33c can also be ensured, thereby more effectively improving the dissociation efficiency of the second laser beam 3a emitted by the second laser generator 3.

Still referring to FIG. 2 and FIG. 3, in some embodiments, the substrate 1 includes a standard sample area 1a and a test sample area 1b. A standard sample capable of generating signal ions is placed in the standard sample area 1a. When the first laser beam 2a is irradiated on the standard sample area 1a, a particle plume with high consistency can be generated for a long time and stably as the substrate 1 moves, so that there is sufficient time to adjust the focus of the second laser beam. A sample to be tested is placed in the test sample area 1b, and the ion source 100 according to this embodiment is configured to move the substrate 1 to detect the sample in the test sample area 1b, after determining the destination where the focus FP of the second laser generator 3 is moved to according to the standard sample area 1a. By arranging the standard sample area 1a and the test sample area 1b on the substrate 1, the best relative positions of the laser beams emitted by the first laser generator 2 and the second laser generator 3 can be obtained by testing the standard sample in the standard sample area 1a. Further, by moving the substrate 1 instead of moving the first laser generator 2 or the second laser generator 3, the sample in the test sample area 1b can be detected while the relative position between the first laser generator 2 and the second laser generator 3 is kept fixed. By using the standard sample, the calibration process can be simplified and the accuracy and repeatability of the calibration can be improved.

FIG. 4 is a schematic structural diagram of a system of a mass spectrometer according to some embodiments of this application. Referring to FIG. 4, the mass spectrometer according to this embodiment may include the ion source 100 according to any one of the above embodiments, a vacuum port 200, an ion guiding device 300, and a mass detector 400. The ion source 100 is an atmospheric pressure ion source. After a sample is dissociated in the atmospheric pressure environment, the sample is introduced into the vacuum environment through the vacuum port 200, and is further guided to the mass detector 400 through the ion guiding device 300. The mass detector 400 may be, for example, the mass detector 400 of the time-of-flight mass spectrometer or the quadrupole-based mass detector 400, which is not limited in this application. The mass detector 400 may be the detector 4 in the above embodiments, or may be an independent mass detector 400 different from the detector 4, which is not limited in this application.

This embodiment provides a method for generating ions, which is applicable to the ion source 100 with the above structure and the mass spectrometer.

FIG. 5 is a flowchart of a method for generating ions according to one or more embodiments of this application. As shown in FIG. 5, the method for generating ions according to this embodiment includes the following steps:
Step S1: desorbing and ionizing a sample by the first laser beam 2a to obtain a particle plume PP;
Step S2: ionizing the particle plume PP by the second laser beam 3a to obtain signal ions;
Step S3: moving a focus of the second laser beam 3a, meanwhile, detecting a signal intensity of the signal ions;
Step S4: determining the destination of the focus of the second laser beam 3a based on comparison between different signal intensities corresponding to different focuses; and
Step S5: immobilizing the focus of the second laser beam 3a at the destination.

Specifically, the method for generating ions according to this embodiment will be described based on the ion source 100 shown in FIG. 1.

In step S1, a sample is placed on the substrate 1, the first laser generator 2 emits the first laser beam 2a to the sample on the substrate 1, the sample is desorbed and ionized, and the generated sample ions diffuse in a direction away from the substrate 1 to generate a particle plume PP.

In step S2, the second laser generator 3 emits the second laser beam 3a to the sample on the substrate 1, the second laser beam 3a is focused on the particle plume PP, and the particles in the particle plume PP are further ionized to generate more signal ions.

In step S3, the actuating device 5 controls the focus of the second laser generator 3 to move within and around the region of the particle plume PP. The movement includes a movement in a direction perpendicular to the substrate 1 and a movement in a direction parallel to the substrate 1, in other words, the movement of the focus which the actuating device 5 operates has a component in the direction parallel to the surface of the substrate 1 and a component in the direction perpendicular to the surface of the substrate 1. Through the three-dimensional movement, the focus of the second laser generator 3 that maximizes the post-ionization effect can be determined. During the movement of the focus of the second laser generator 3 in step S3, the detector 4 always keeps working, and detects and records the signal intensity in real time.

In step S4, the controller acquires the signal intensities of the signal ions detected by the detector 4 when the second laser generator 3 focuses on different positions, and determines the destination of the focus of the second laser beam 3a based on the comparison between the signal intensities.

In step S5, a movable part of the second laser generator 3 is arranged, so that the position/orientation state of the second laser generator 3 changes from movable to immovable (fixed). For example, the position/orientation of the second laser generator 3 is locked by a locking mechanism, and the focus of the second laser beam 3a emitted by the second laser generator 3 is immobilized at the destination determined in step S4, so as to always maintain the focus of the second laser generator 3 at the destination in the subsequent analysis process.

A person of ordinary skill in the art may understand that all or some of the steps of the above embodiment may be implemented by hardware, or may be implemented by a program instructing related hardware, the program may be stored in a computer-readable storage medium, and the storage medium may be a read-only memory, a magnetic disk, an optical disk, or the like.

The technical solutions of this application have been described with reference to the accompanying drawings, but it is easily understood by those skilled in the art that the protection scope of this application is obviously not limited to these specific embodiments. Those skilled in the art can make equivalent changes or substitutions to related technical features without departing from the principle of this application, and the technical solutions after these changes or substitutions shall fall within the protection scope of this application.

What is claimed is:

1. An ion source comprising:
a substrate for carrying a sample;
a first laser generator projecting a first laser beam to the substrate, thereby desorbing and ionizing the sample to obtain a particle plume;
a second laser generator for ionizing the particle plume to obtain signal ions, focus of the second laser generator being located on a side of the sample away from the substrate and disposed a predetermined distance away from the substrate;
a detector for detecting a signal intensity of the signal ions;
an actuating device configured to move the focus of the second laser generator, the destination where the focus is moved to being determined by comparison between different signal intensities detected by the detector during a movement of the focus.

2. The ion source according to claim 1, wherein the second laser generator comprises a laser emitter and an optical lens assembly, the optical lens assembly is arranged in a laser path of the laser emitter, the actuating device is connected to the optical lens assembly, and the actuating device alters the laser path of the laser emitter by moving or rotating the optical lens assembly.

3. The ion source according to claim 1, further comprising: a sensor that receives a second laser beam from the second laser generator, and the destination of the focus is also determined based on a detection result of the sensor.

4. The ion source according to claim 3, wherein the detection result of the sensor comprises: light spot's shape, light spot's relative position and/or laser energy.

5. The ion source according to claim 1, wherein the second laser generator comprises a reflecting mirror that refocuses a second laser beam, the second laser beam has been focused on a first position of the particle plume, and is refocused on a second position of the particle plume by the reflecting mirror.

6. The ion source according to claim 5, wherein the reflecting mirror is a concave mirror.

7. The ion source according to claim 5, wherein the position or angle of the reflecting mirror is determined by comparison between different signal intensities detected by the detector during a movement or rotation of the reflecting mirror.

8. The ion source according to claim 1, wherein working air pressure of the ion source is 1 Pa-1 atm.

9. The ion source according to claim 8, wherein the ion source is an atmospheric pressure ion source.

10. The ion source according to claim 1, wherein the substrate comprises a standard sample area and a test sample area, and the ion source is configured to move the substrate to detect the sample in the test sample area, after determining the destination where the focus of the second laser generator is moved to according to the standard sample area.

11. An ion source according to claim 1, wherein the movement of the focus which the actuating device operates has a component in a direction parallel to a surface of the substrate.

12. An ion source according to claim 11, wherein the movement of the focus which the actuating device operates further has a component in a direction perpendicular to the surface of the substrate.

13. The ion source according to claim 1, wherein the predetermined distance is 0.01-5 mm.

14. An ion source according to claim 1, characterized in that in a region adjacent to the substrate, a laser path of the first laser generator is in a direction inclined to a surface of the substrate, and a laser path of the second laser generator is in a direction parallel to the surface of the substrate.

15. An ion source according to claim 1, further comprising
a controller in communication with the detector and the actuating device, and the destination of the focus is determined by the controller.

16. A mass spectrometer comprising the ion source according to claim 1.

17. A method for generating ions, comprising following steps:
desorbing and ionizing a sample by a first laser beam to obtain a particle plume;
ionizing the particle plume by a second laser beam to obtain signal ions;
moving a focus of the second laser beam, meanwhile, detecting a signal intensity of the signal ions;
determining the destination of the focus of the second laser beam based on comparison between different signal intensities corresponding to different focuses of the second laser beam;
immobilizing the focus of the second laser beam at the destination.
